(19) United States
(12) Patent Application Publication
(10) Pub. No.: US 2002/0104098 A1
(43) Pub. Date: Aug. 1, 2002

(54) Subscriber class television channel with class member programming

(76) Inventors: Fred J. Zustak, Poway, CA (US); Matthew S. Chang, San Diego, CA (US); Aditya Krishnan, San Diego, CA (US); Andrew M. Proehl, San Francisco, CA (US); David K.L. Yang, San Jose, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/774,458

(22) Filed: Jan. 31, 2001

(51) Int. Cl. H04N 7/173; G09G 5/00

(52) U.S. Cl. 725/131; 725/106; 345/731; 345/748

(57) ABSTRACT

A subscriber class leases and provides programming for a digital television channel using the two way communication capabilities of a digital set-top box. Programming content is uploaded by members of the subscriber class to a service provider using upstream communication such as a cable modem forming a part of the set-top box. A schedule arbiter schedules the programming and the programming is multicast to the class of subscribers for playback.

### FIELD OF THE INVENTION

This invention relates generally to the field of interactive television. More particularly, this invention relates to a television programming method and apparatus in which members of a class of subscribers are able to provide content for a television channel.

### BACKGROUND OF THE INVENTION

Television set-top boxes were initially introduced to provide tuning capabilities for cable and satellite television systems. While these devices still provide that fundamental function, digital set-top boxes now often incorporate powerful computers in the latest generation of set-top boxes. With such computers available, and with the low cost necessitated by the high volume production of such devices, it is now possible to expand the usefulness of the television set-top box beyond that of merely providing tuning functions for cable and satellite systems. One such new function provided by networks of digital set-top boxes involves enhanced communications made possible by digitizing the television channels and providing cable modem communication capabilities.

### SUMMARY OF THE INVENTION

The present invention relates generally to a subscriber programmed television channel. Objects, advantages and features of the invention will become apparent to those skilled in the art upon consideration of the following detailed description of the invention.

In one embodiment consistent with the present invention, a subscriber class leases and provides programming for a digital television channel using the two way communication capabilities of a digital set-top box. Programming content is uploaded by members of the subscriber class to a service provider using upstream communication such as a cable modem forming a part of the set-top box. A schedule arbiter schedules the programming, and the programming is multicast to the class of subscribers for playback.

A method of providing a channel of television programming to a class of subscribers in accordance with an embodiment of the present invention includes: receiving programming content from a first subscriber, the first subscriber being one of the class of subscribers, the programming content being transmitted electronically from the first subscriber via a first subscriber's set-top box; and multicasting the programming content to the class of subscribers, the multicasting being carried out by addressing a set-top box corresponding to each subscriber belonging to the class of subscribers.

Another method of providing a channel of television programming to a class of subscribers in accordance with an embodiment of the invention, wherein the class of subscribers includes one of a family, affiliates of a corporate entity, and people with a common interest, includes: receiving programming content from a first subscriber, the first subscriber being one of the class of subscribers, the programming content being transmitted electronically from the first subscriber via a first subscriber's set-top box; wherein the programming content is received from the first subscriber by an upload to a service provider via one of a dial-up narrowband telephone communication link, a wideband telephone communication link, and a cable modem communication link; and multicasting the programming content over a leased digital television channel to the class of subscribers, the multicasting being carried out by addressing a set-top box corresponding to each subscriber belonging to the class of subscribers by: encrypting the programming content using an encryption key; providing the encryption key to the class of subscribers; and broadcasting the encrypted programming content to the class of subscribers.

Another method of providing a channel of television programming to a class of subscribers consistent with embodiments of the invention includes: establishing the class of subscribers and leasing a television channel from a service provider; electronically transmitting programming content from a first subscriber to the service provider, the first subscriber being one of the class of subscribers, the programming content being transmitted from the first subscriber via the first subscriber's set-top box; scheduling playback of the programming content; and multicasting the programming content over the leased television channel to the class of subscribers.

Another method of providing a channel of television programming to a class of subscribers consistent with embodiments of the invention includes: establishing the class of subscribers and leasing a digital television channel from a service provider; electronically transmitting programming content from a first subscriber to the service provider, the first subscriber being one of the class of subscribers, the programming content being transmitted from the first subscriber via the first subscriber's set-top box; wherein the programming content is received from the first subscriber by an upload to the service provider via one of a dial-up narrowband telephone communication link, a wideband telephone communication link, and a cable modem communication link; wherein the programming content is received from the first subscriber by an upload to a service provider of content from one of a still camera, a video camera, a video tape player, an audio tape player, a CD players, a PVR, and a scanner; a schedule arbiter scheduling playback of the programming content; multicasting the programming content over the leased television channel to the class of subscribers by addressing a set-top box corresponding to each subscriber belonging to the class of subscribers for transmission of the content by: encrypting the programming content using an encryption key; providing the encryption key to the class of subscribers; broadcasting the encrypted programming content to the class of subscribers; removing the programming content from the schedule by: requesting a schedule arbiter to remove the content; and the schedule arbiter removing the content.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 illustrates a network of set-top boxes at a plurality of subscriber sites coupled to a service provider to implement the system of the present invention.

FIG. 4 is a flow chart illustrating one embodiment consistent with the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

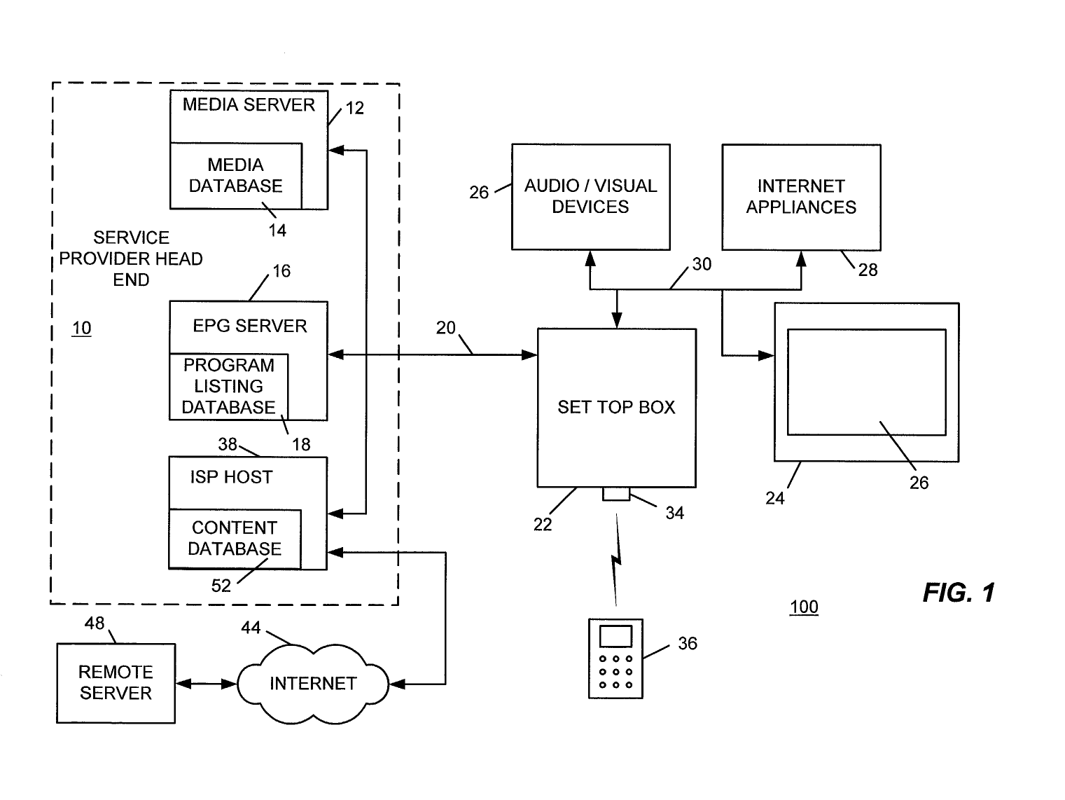

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

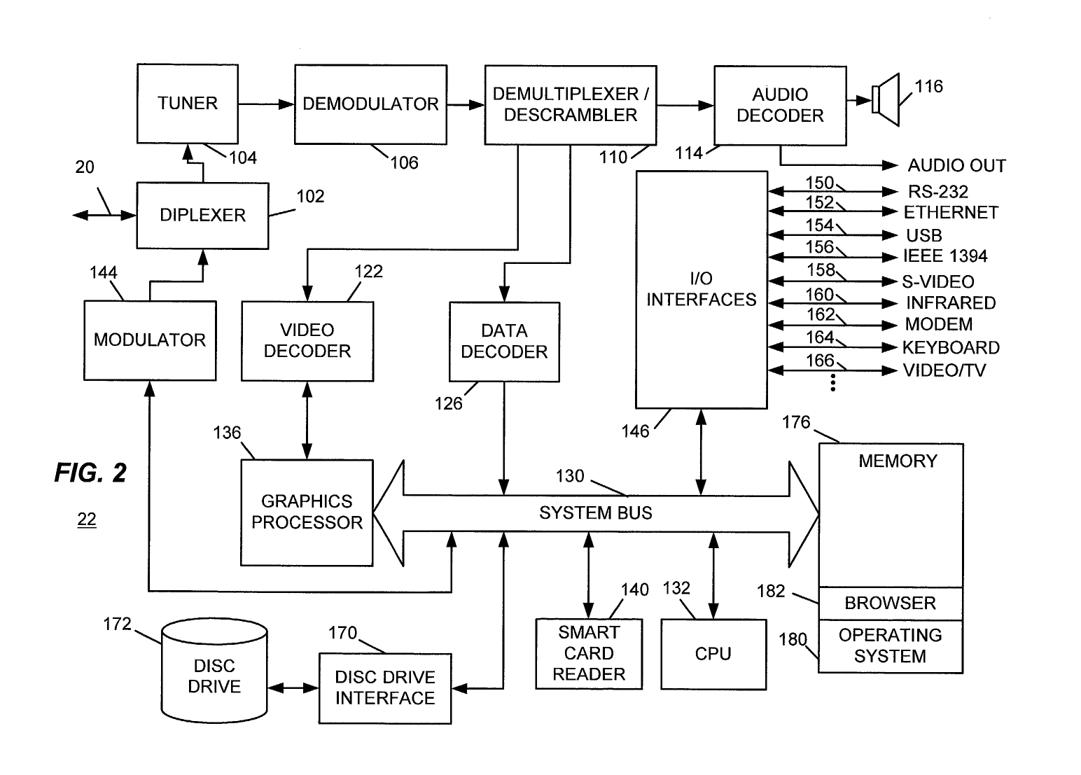

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of 1/0 devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as VxWorks, Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

With the advent of modern digital set-top boxes, digital television and wideband distribution media (e.g., wideband cable and fiber optic networks), many service providers will have dramatic increases in bandwidth available to provide television content. In such a scenario, groups (classes) of subscribers may wish to band together to lease bandwidth for private programming. Moreover, the members of the subscriber class may be provided with the ability to submit programming content according to embodiments of the present invention.

In accordance with the present invention, STB 22 can be utilized to provide a television channel to a class of subscribers of which the subscriber controlling STB 22 is a member. Moreover, in accordance with embodiments of the present invention, the television channel is controlled and programmed by the class of subscribers. In the present document, the term “class of subscribers,” “class,” and “subscriber class” are intended to embrace a collection of subscribers who choose to lease an actual or virtual television channel from a service provider such as service provider 10. For example, an organization such as a club, a church, a family, a company or other collection of people with a common binding interest may wish to lease bandwidth on a television system as a subscriber class to provide information to a private collection of viewers (the class). Moreover, it may be desirable for such a class of subscribers to provide programming to the television channel.

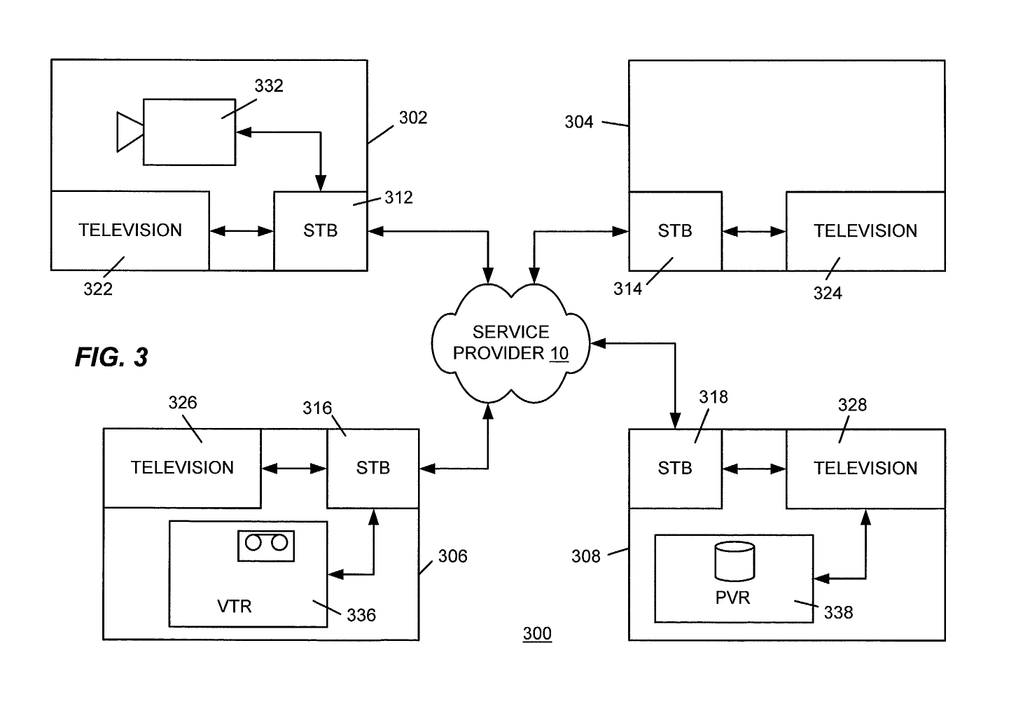

The capabilities of a modern digital set-top box make such a television channel with a class of subscribers that provides their own programming a feasible mechanism for enhancing communication among a collection of people. FIG. 3 provides a simple illustration of a network 300 of four subscribers at subscriber sites 302, 304, 306 and 308 all coupled to a service provider 10 via the transmission medium of the network (e.g., cable or fiber). Each of these subscribers sites includes a set-top box 312, 314, 316 and 318 respectively that couples the site to the service provider 10's network. Also, each subscriber site includes a display such as a television set 322, 324,326 and 326 for viewing programming provided by the respective set-top boxes. In another embodiment, not shown, the functionality of the set-top box is included in the television set.

Beyond this basic set of hardware, the individual subscriber sites may include any number of other types of hardware that can be used to provide programming to the leased channel. In the exemplary network 300 as illustrated, site 302 includes a camera 332 (either still, analog or digital video, or surveillance, for example). Site 306 includes a video tape recorder (VTR, e.g., a video cassette recorder or VCR). Site 308 includes a personal video recorder 338 while site 304 is illustrated as only having playback capabilities.

In an exemplary embodiment consistent with the present invention, assume that the class of subscribers is a family with four residences participating as subscriber sites (of course a class is not limited to four subscriber sites). Site 302 might represent a vacation home with one or more surveillance cameras represented by camera 332 that periodically uploads images of the property to the service provider 10. In other scenarios, the programming can be set up to provide surveillance on an elderly or shut-in relative, a child with live-in care, etc. Site 304 might represent a family member that only has playback capability, while sites 306 and 308 represent family households that can provide programming via recorded programming from, for example, a PVR or VTR. By way of example, special family events (weddings, vacations, birthday parties, etc.) can be uploaded from PVR 338 or VTR 336 (or other sources such as cameras, etc.) to the service provider 10 to form a part of the programming. Programming can be provided by uploading files received from any suitable device including but not limited to still cameras, video cameras, video tape players, audio tape players, CD players, PVRs, scanners, etc. using conventional file upload techniques via modem.

The programming content can be uploaded to the service provider 10, for example using wideband cable modem transmissions from the set-top boxes. In other embodiments, however, the programming content can be uploaded via dial up (narrow-band) or DSL (broadband) telco modems or any other suitable upstream communication mechanism available to the set-top box. Other suitable mechanisms include, but are not limited to fiber channels, wireless cellular networks, and the like. The programming content is mutlicast in a somewhat conventional fashion to the set-top boxes associated with the class of subscribers. This can be accomplished in several ways. In one embodiment, the programming content can be encrypted with only the class of subscribers having set-top boxes equipped with the appropriate decryption capabilities for decrypting the content. Other subscribers outside the class are thus locked out of reception of the programming content. This is accomplished in one embodiment in the same manner as pay programming or pay per view programming using digital or analog set-top boxes. In certain embodiments, the IP address or other unique identifier of the set-top box is used to address the set-top box and enable receipt of programming by, for example, providing a key for decryption. The decryption key can be transmitted, for example, over a video channel, or over a communication channel via modem.

When the programming content is uploaded to the service provider 10, the service provider 10 can store the programming content, for example, in the media server 12 in media database 14. In other implementations, a dedicated server can be provided for leased channels.

When the programming content is received, it is scheduled by any suitable scheduling mechanism for playback as a television program. In one embodiment, the content can be scheduled automatically by the media server. In another embodiment, the content can be scheduled during submission of programming content. In yet another embodiment, the programming can be scheduled by a schedule arbiter that is a member of the subscriber class appointed by the subscriber class to handle the mechanics of scheduling. In yet another embodiment, the content may be downloaded to a subscriber's STB either by a predetermined schedule or on-demand, for storage to a memory for delayed downloading.

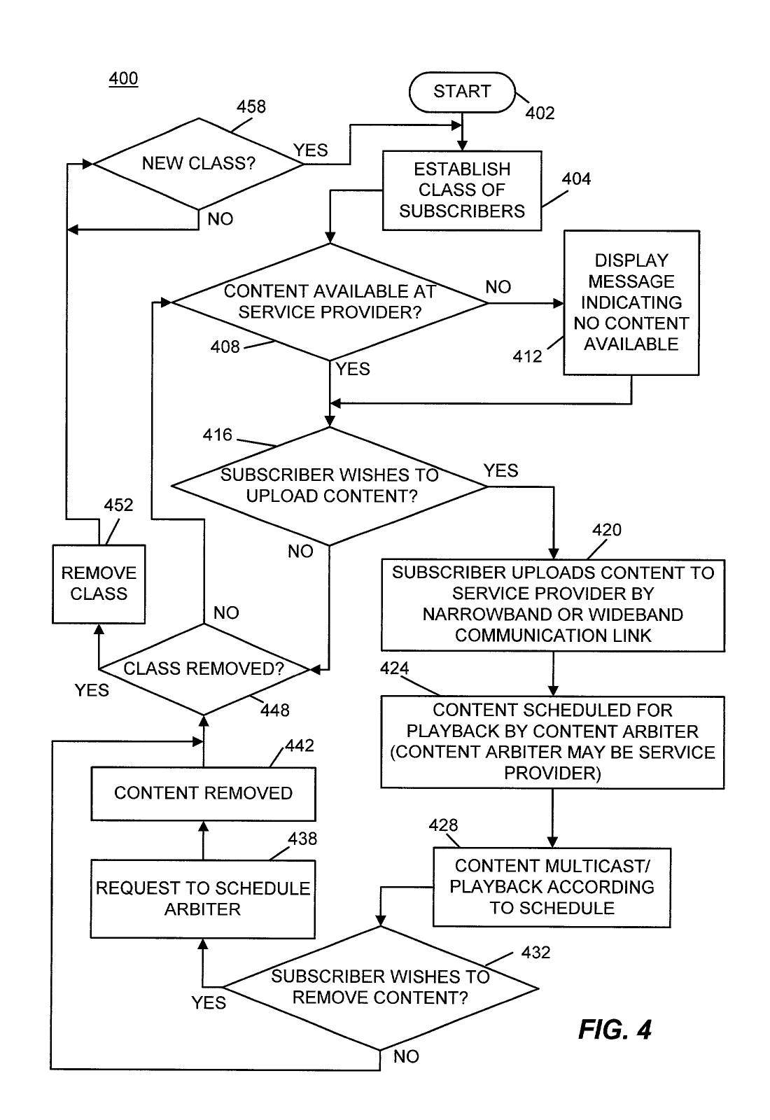

FIG. 4 illustrates a process 400 starting at 402 in which programming is received, scheduled by a schedule arbiter and multicast to the subscriber class. At 404 a class of subscribers initiates creation of their television channel or virtual channel by establishing a class with the service provider and leasing the channel. Note that the channel may be shared with other classes on a time shared basis or may be leased exclusively to the subscriber class. Initially, of course, there is likely no content (unless supplied by the service provider). If no content is available at 408, a message may be displayed to the subscriber class 412 indicating there is no content, but it may also identify the subscriber class and provide confirmation that the channel is operational. At 416, control passes to 416 until a subscriber wishes to upload programming content to the service provider 10. The subscriber then uploads the content to the service provider using narrow band or wide band communication capabilities at 420. The content is then scheduled for playback and multicast to the subscribers by the content arbiter at 424. If this is the first content uploaded or the only content available, it may be programmed automatically for continuous playback. After scheduling, the content is played back at 428 (that is, multicast to the members of the subscriber class) in accord with the playback schedule established by default or by the schedule arbiter.

If a subscriber wishes to remove content he previously submitted at 432, a request is submitted to the schedule arbiter at 438 and, assuming approval, the content is removed at 442. In the embodiment illustrated, the schedule arbiter may be a subscriber class member and may directly remove content as desired without the request process illustrated without departing from the invention. If no content is to be removed at 432 or after the content is removed at 442, the class is to be removed (e.g., by initiation of the class or service provider, for example due to expiration or non-renewal of the lease, or violation of rules) at 448, the class is removed at 452 freeing the bandwidth allocated to the channel and control passes to 458 where formation of a new class is awaited to reallocate the bandwidth and return to 404. If the class remains intact at 448, control passes to 408.

Of course, those skilled in the art will recognize many alternatives for implementation of a process for providing a private channel to a class of subscribers within the scope of the invention without necessarily using all of the details described herein. The present invention, thus, provides for a class of subscribers to essentially own and manage their own television channel in accordance with the embodiments illustrated above and equivalents thereof.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and which can be stored in any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing a channel of television programming to a class of subscribers, comprising:
receiving programming content from a first subscriber, the first subscriber being one of the class of subscribers, the programming content being transmitted electronically from the first subscriber via a first subscriber's set-top box; and
multicasting the programming content to the class of subscribers, the multicasting being carried out by addressing a set-top box corresponding to each subscriber belonging to the class of subscribers.

2. The method according to claim 1, wherein the programming content is received from the first subscriber by an upload to a service provider via a dial-up narrowband telephone communication link.

3. The method according to claim 1, wherein the programming content is received from the first subscriber by an upload to a service provider via a wideband telephone communication link.

4. The method according to claim 1, wherein the programming content is received from the first subscriber by an upload to a service provider via a cable modem communication link.

5. The method according to claim 1, wherein the multicasting comprises multicasting the programming content over a leased digital television channel.

6. The method according to claim 1, wherein the multicasting is carried out by:
encrypting the programming content using an encryption key;
providing the encryption key to the class of subscribers; and
broadcasting the encrypted programming content to the class of subscribers.

7. The method according to claim 1, wherein the class of subscribers comprise one of a family, affiliates of a corporate entity, and people with a common interest.

8. The method according to claim 1, wherein the programming content is received from the first subscriber by an upload to a service provider of content from one of a still camera, a video camera, a video tape player, an audio tape player, a CD players, a PVR and a scanner.

9. A method of providing a channel of television programming to a class of subscribers, wherein the class of subscribers comprise one of a family, affiliates of a corporate entity, and people with a common interest, the method comprising in combination:
receiving programming content from a first subscriber, the first subscriber being one of the class of subscribers, the programming content being transmitted electronically from the first subscriber via a first subscriber's set-top box;
wherein the programming content is received from the first subscriber by an upload to a service provider via one of a dial-up narrowband telephone communication link, a wideband telephone communication link and a cable modem communication link; and
multicasting the programming content over a leased digital television channel to the class of subscribers, the multicasting being carried out by addressing a set-top box corresponding to each subscriber belonging to the class of subscribers by:
encrypting the programming content using an encryption key;
providing the encryption key to the class of subscribers; and
broadcasting the encrypted programming content to the class of subscribers.

10. A method of providing a channel of television programming to a class of subscribers, comprising:
establishing the class of subscribers and leasing a television channel from a service provider;
electronically transmitting programming content from a first subscriber to the service provider, the first subscriber being one of the class of subscribers, the programming content being transmitted from the first subscriber via the first subscriber's set-top box;
scheduling playback of the programming content; and
multicasting the programming content over the leased television channel to the class of subscribers.

11. The method according to claim 10, wherein the multicasting is carried out by addressing a set-top box corresponding to each subscriber belonging to the class of subscribers for transmission of the content.

12. The method according to claim 11, wherein the multicasting is carried out by:
encrypting the programming content using an encryption key;
providing the encryption key to the class of subscribers; and
broadcasting the encrypted programming content to the class of subscribers.

13. The method according to claim 10, wherein the television channel comprises a digital television channel.

14. The method according to claim 10, wherein the programming content is received from the first subscriber by an upload to the service provider via one of a dial-up narrowband telephone communication link, a wideband telephone communication link and a cable modem communication link.

15. The method according to claim 10, wherein the programming content is received from the first subscriber by an upload to a service provider of content from one of a still camera, a video camera, a video tape player, an audio tape player, a CD players, a PVR and a scanner.

16. The method according to claim 10, further comprising removing the programming content by:
requesting a schedule arbiter to remove the content; and
the schedule arbiter removing the content.

17. The method according to claim 10, wherein the scheduling is carried out by a schedule arbiter.

18. A method of providing a channel of television programming to a class of subscribers, comprising:
establishing the class of subscribers and leasing a digital television channel from a service provider;
electronically transmitting programming content from a first subscriber to the service provider, the first subscriber being one of the class of subscribers, the programming content being transmitted from the first subscriber via the first subscriber's set-top box;
wherein the programming content is received from the first subscriber by an upload to the service provider via one of a dial-up narrowband telephone communication link, a wideband telephone communication link and a cable modem communication link;
wherein the programming content is received from the first subscriber by an upload to a service provider of content from one of a still camera, a video camera, a video tape player, an audio tape player, a CD players, a PVR and a scanner;
a schedule arbiter scheduling playback of the programming content;
multicasting the programming content over the leased television channel to the class of subscribers by addressing a set-top box corresponding to each subscriber belonging to the class of subscribers for transmission of the content by:
encrypting the programming content using an encryption key;
providing the encryption key to the class of subscribers;
broadcasting the encrypted programming content to the class of subscribers;
removing the programming content from the schedule by:
requesting a schedule arbiter to remove the content; and
the schedule arbiter removing the content.
